(19) United States
(12) Patent Application Publication
(10) Pub. No.: US 2014/0063726 A1
(43) Pub. Date: Mar. 6, 2014

(54) COMPUTER COOLING SYSTEM

(71) Applicant: You-Chi LIU, Taipei City (TW)

(72) Inventor: You-Chi LIU, Taipei City (TW)

(73) Assignees: You-Chi LIU, Taipei City (TW); Alex HOU, Hsinchu County (TW)

(21) Appl. No.: 13/605,492

(22) Filed: Sep. 6, 2012

(51) Int. Cl. G06F 1/20

(52) U.S. Cl. 361/679.33

(57) ABSTRACT

The present invention relates to a computer cooling system for using in a computer. The computer includes an accommodation chamber having a first, a second and a third accommodation spaces. The first accommodation space receives a motherboard and HDD and burner connected electrically to the motherboard, and includes one or more first air inlets and air outlets for discharging hot air on the two adjacent side walls. The second accommodation space is arranged according to the position of the interface and memory cards on the motherboard and includes one or more second air inlets and second air outlets for discharging hot air. A third accommodation space accommodates the power supply and includes one or more third air inlets and third air outlets for discharging hot air. The arrangement of the accommodation assists cooling down the computer quickly.

### BACKGROUND OF THE INVENTION

1. Field of the Invention

The present invention relates to a computer cooling system, particularly to a cooling system capable of keeping good air circulating inside the computer. The computer comprises an accommodation chamber which is divided into multiple accommodation spaces and air inlets and air outlets are provided in the accommodation spaces to draw in cold air to the computer and discharge hot air from the accommodation chamber to the surrounding, thus quickly achieving the cooling effect.

2. Description of the Related Art

In present times, rapid developments of electronic technology and multimedia information offer efficient functions through computer technology, allowing people to enjoy convenient, comfortable and quick working and living conditions. As electronic technology and computer systems become more powerful and are used more widely, electronic and electric products are more or less used in daily life, work, study or entertainments. In particular, computers are most closely related to people's life, work or study. With Internet that goes beyond state boundaries and gets rid of limitations or obstacles in time and space, a lot of work can be done with computers. Many operations are completed by computers, and this also results in much dependence on computers. Moreover, due to advantages in convenience, quickness and accuracy, etc, computers are applied more widely. As application functions of computers become more and more powerful, devices inside computers tend to become more sophisticated. Particularly, multiple central processing units (CPU) are installed on motherboards to enable executions by computers in shorter time periods. While application of CPUs, from single-core ones in early stages to dual-core and quad-core CPUs at the present time, makes it possible to enhance computers' functions, these computers will generate relatively more heat while working, leading to higher temperature within the computers. Therefore, computer cooling is another question that must be taken seriously. In addition to installing cooling modules such as fins and cooling fans close to heat sources on the motherboard, many computer manufacturers also install fans onto computer cases to assist with discharging hot air from inside computers through multiple ventilation apertures in the rear side of computers. However, this method still has disadvantages in practical applications, for example:

(1) since cooling fans are installed on the motherboard to remove hot air from heat sources inside computers, if the fans on the computer cases blow cold air inwards, a lot of air flows will move randomly in all directions, causing considerable noise inside the computers and affecting the cooling effect.

(2) heat sources on the motherboard are distributed on different positions, and other necessary devices on the motherboard also generate heat while working, such as the power supply, burner or disc drives, etc, but cooling fans on the computer cases cannot blow cold air to and discharge hot air from these devices, making it difficult to discharge hot air from inside the computers.

Thus, how to solve the existing problem of difficulty in discharging hot air from computers and in preventing cold air from flowing in all directions as well as noise inside computers due to operations is what the firms engaged in this field need urgently to research and improve.

### SUMMARY OF THE INVENTION

In view of the aforesaid problems and disadvantages, the inventor has collected related information, conducted assessments and taken considerations in many aspects, and based on his own experience of many years in this industry, has finally invented this computer cooling system that divides the computer's internal space effectively and provides air inlets and air outlets to assist with heat dissipation from the computer's accommodation chamber.

The primary object of the present invention is to provide a computer cooling system for using in a computer. The computer comprises an accommodation chamber which is partitioned into a first, a second and a third accommodation spaces. The first accommodation space accommodates the motherboard, CD/DVD drive and burner, and includes one or more first air inlets at one side wall and air outlets for discharging hot air on two adjacent side walls. The second accommodation space is arranged according to the position of the CPU on the motherboard and includes one or more second air inlets on one side wall and one or more air outlets for discharging hot air on other two opposite side walls. The third accommodation space is used to accommodate the power supply and includes one or more third air inlets on one side wall and one or more third air outlets for discharging hot air on the two adjacent side walls. With this arrangement, the purpose of good air circulation inside the computer and quick cooling effect is achieved.

The secondary object of the present invention is to install ordinary mechanical or water-cooled fans onto various air inlets on side walls of the computer, or to use multiple ventilation apertures or exhaust mechanical or water-cooled fans to replace the air outlets on side walls.

### BRIEF DESCRIPTION OF THE DRAWINGS

FIG. 1 is an exploded view of the internal space of a computer according to the present invention.

FIG. 2 is an exploded view of the present invention.

FIG. 3 is a perspective view according to a preferred embodiment of the present invention.

FIG. 4 is a perspective view according to another preferred embodiment of the present invention.

### DETAILED DESCRIPTION OF THE PREFERRED EMBODIMENT

To achieve the aforesaid objects and functions as well as the techniques adopted in the present invention and its fabrication, examples of the preferred embodiments of the present invention are given below to illustrate features and functions of the present invention in detail by referring to the accompanying drawings.

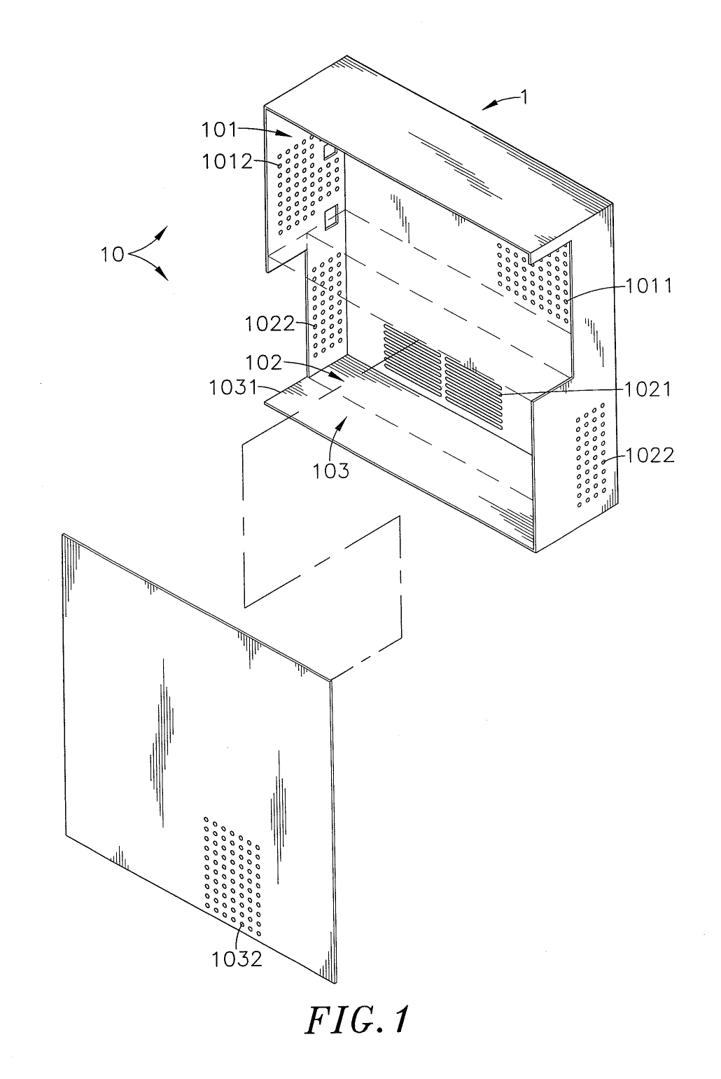

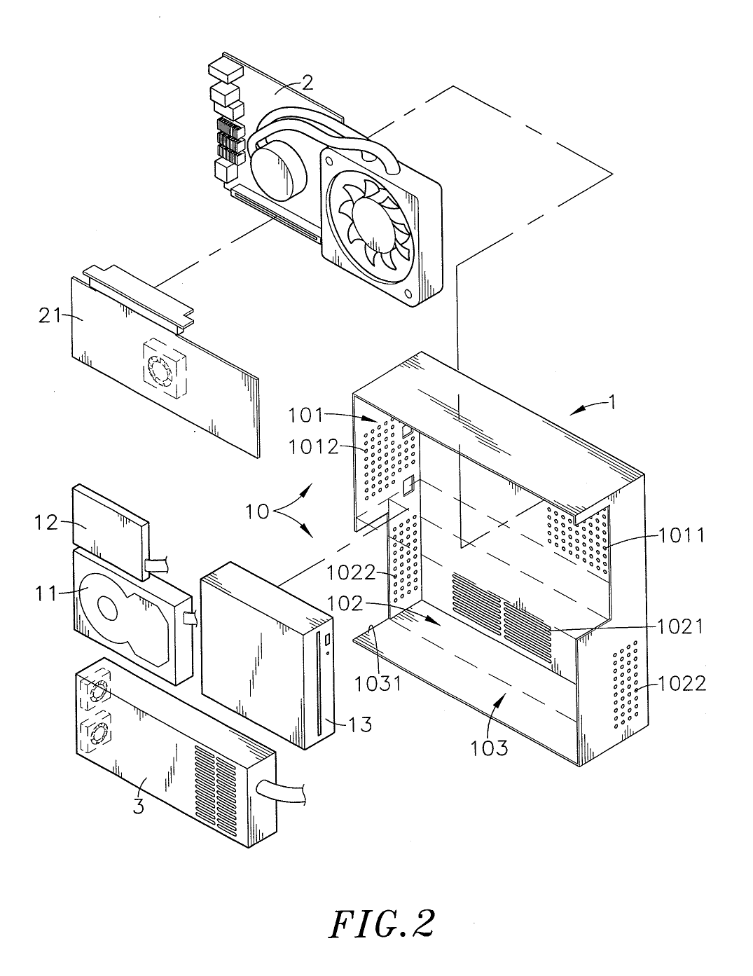

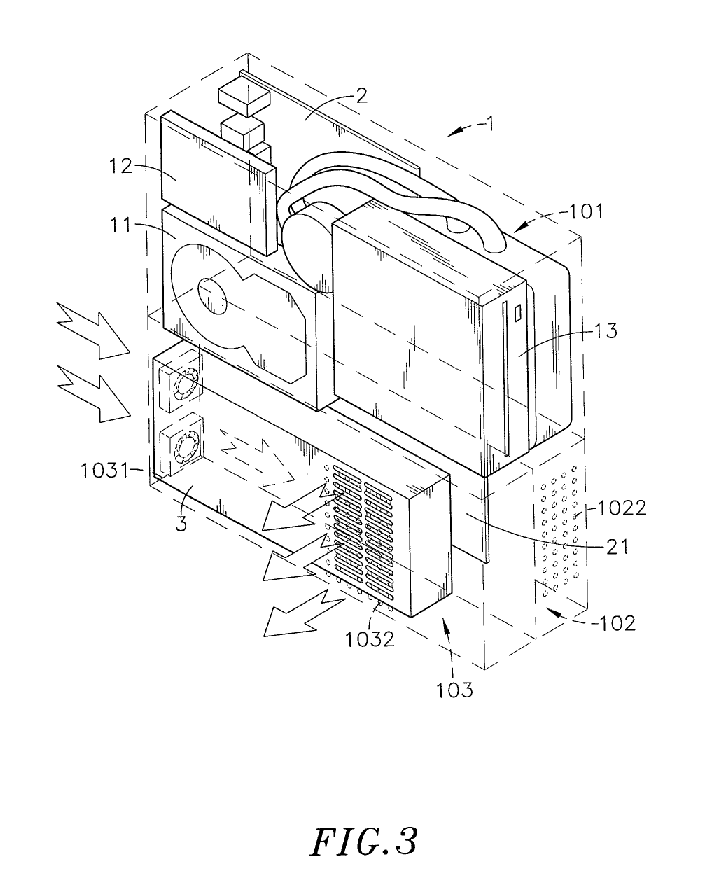

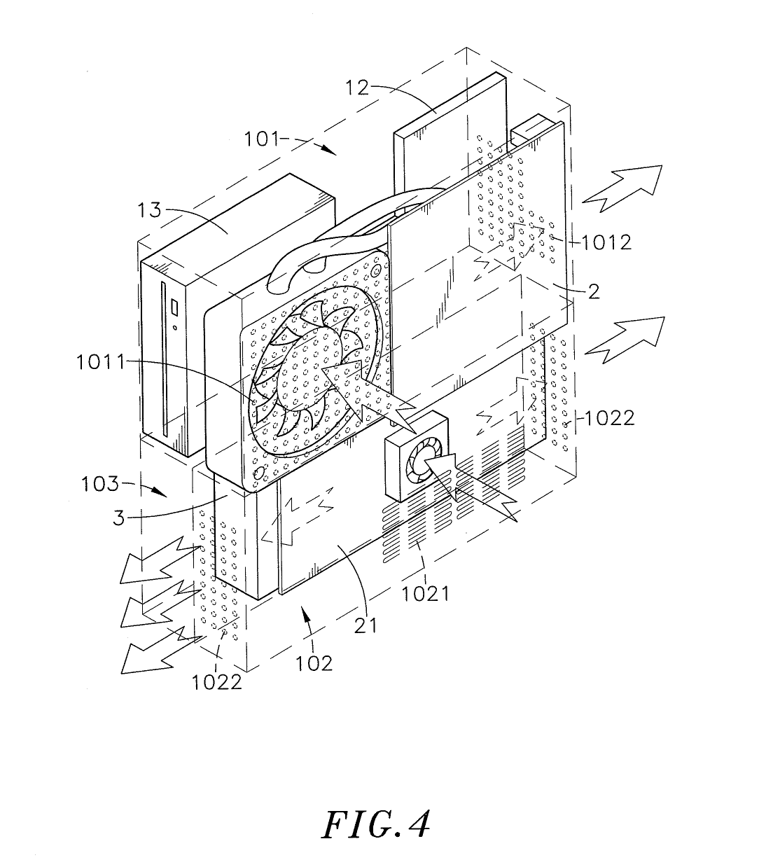

Refer to FIGS. 1, 2, 3 and 4, which are respectively the exploded views of the internal space of a computer and of the present invention, and perspective views according to preferred embodiments of the present invention. As shown clearly in these figures, the computer cooling system of the present invention includes a computer 1, a motherboard 2 and a power supply 3.

The computer 1 includes an accommodation chamber 10 inside to accommodate the motherboard 2, an interface card 21, a memory card, the power supply 3 and other devices such as a hard disc drive (HDD) 11, CD/DVD drive 12 or a burner 13, etc.. The accommodation chamber 10 is divided into a first accommodation space 101, a second accommodation space 102 and a third accommodation space 103, wherein the first accommodation space 101 is used to accommodate the motherboard 2 and the HDD 11, CD/DVD drive 12 and burner 13 that are electrically connected to the motherboard 2, and one or more first air inlets 1011 and first air outlets 1012 for discharging hot air outwards are provided on two adjacent side walls of the first accommodation space 101. The second accommodation space 102 is arranged according to the positions of heat-generating electronic components and devices, such as the interface card 21 and memory card, and on one side wall of it, one or more second air inlets 1021 are provided, while one or more air outlets 1022 are provided on two opposite side walls adjacent to the second air inlet 1021. The third accommodation space 103 receives the power supply 3, and one or more third air inlets 1031 are provided on one side wall of it, while one or more third air outlets 1032 are provided on the side wall of the third accommodation space 103 adjacent to the air inlet.

Cold air can be drawn in the accommodation chamber 10 of the computer 1 through the air inlets 1011, 1021 and 1031 provided on the side walls of the first, second and third accommodation spaces 101, 102 and 103 respectively. Besides, fans (usually mechanical fans or water-cooled fans, etc) may be installed on the air inlets 1011, 1021 and 1031 respectively to draw external cold air into the accommodation spaces 101, 102 and 103.

In addition, the heat generated from the motherboard 2, interface card 21, HDD 11, CD/DVD drive 12 and burner 13, and power supply 3, together with the hot air accumulated inside the accommodation chamber 10 of the computer 1, can be discharged through the air outlets 1012, 1022 and 1032 provided on other side walls of the accommodation spaces 101, 102 and 103. The air outlets 1012, 1022 and 1032 may be multiple in number, or equipped with fans (ordinary mechanical fans or water-cooled fans, etc.) respectively to discharge hot air from the accommodation spaces 101, 102 and 103 of the computer 1.

External cold air can be drawn in the computer 1 through the air inlets 1011, 1021 and 1031 on side walls of the accommodation spaces 101, 102 and 103 of the accommodation chamber 10, while internal hot air can be discharged from the computer 1 through the air outlets 1012, 1022 and 1032 on different side walls of the accommodation spaces, thus keeping fresh air flowing into the accommodation spaces 101, 102 and 103 and achieving the cooling effect quickly. Besides, through the air inlets 1011, 1021 and 1031 and air outlets 1012, 1022 and 1032 of the accommodation spaces 101, 102 and 103, cold and hot air can quickly flow into and out of the accommodation chamber 10, thus making no noises by preventing cold and hot air from flowing in all directions inside the accommodation chamber 10.

A sheet of metal, plastic, acrylic or other materials may be used to partition the accommodation chamber 10 of the computer 1 into the accommodation spaces 101, 102 and 103. The power supply 3 installed inside the third accommodation space 103 is used for providing electricity to the motherboard 2 and related electronic devices including HDD 11, CD/DVD drive 12 and burner 13 etc. The motherboard 2 includes a CPU, at least one chip, at least one interface card 21 and at least one memory card, and necessary electronic components, wherein the CPU or chip is able to execute programs and operating, calculating, processing and editing functions.

The aforesaid descriptions are given to illustrate an example of preferred embodiments of the present invention, and shall not be construed as limiting the appended patent claims of the present invention. The computer cooling system as disclosed in the present invention guides external cold air through the air inlets 1011, 1021 and 1031 into the accommodation chamber 10 of the computer 1, which is divided into the accommodation spaces 101, 102 and 103 to accommodate the motherboard 2, HDD 11, CD/DVD drive 12 and burner 13, interface card 21 or memory card and power supply 3 respectively, and discharges hot air from the accommodation spaces 101, 102 and 103 through the air outlets 1012, 1022 and 1032, so as to keep the accommodation chamber 10 of the computer 1 ventilated and achieve cooling effect quickly. It eliminates noises by preventing cold and hot air from flowing randomly in all directions inside the computer 1, and can quickly dissipate heat generated by the HDD 11, CD/DVD drive 12 and burner 13, motherboard 2, interface card 2, various electronic components and power supply 3, thus prolonging their service life and enhancing the cooling effect for the computer 1. It is hereby declared that all structures and devices that can achieve the aforesaid functions shall be covered by the present invention, and that all modifications and equivalent structural changes made without departing from the spirit and art of the present invention shall be included in the appended patents of the present invention.

In practical applications, the computer cooling system of the present invention has the advantages as follows:

(1) the accommodation chamber 10 of the computer 1 is divided into multiple accommodation spaces 101, 102 and 103 and allows cold and hot air to circulate through the air inlets 1011, 1021 and 1031 and air outlets 1012, 1022 and 1032, without accumulating inside the accommodation chamber 10. So it can avoid making any noise and maintain sound cooling effect.

(2) the motherboard 2, interface card 21, HDD 11, CD/DVD drive 12, burner 13 and power supply 3, etc. are received in the multiple accommodation spaces 101, 102 and 103 of the accommodation chamber 10 inside the computer 1, so different heat sources are separated from each other to quickly dissipate the heat from the accommodation chamber 10.

The present invention mainly deals with the design of a computer cooling system. It divides the accommodation chamber of the computer into multiple accommodation spaces to receive the motherboard, interface card, HDD, CD/DVD drive, burner and power supply respectively, and utilizes one or more air inlets and air outlets on side walls of the accommodation spaces to make cold and hot air circulate quickly inside the computer, thus achieving the cooling effect quickly and avoiding any noise by preventing cold and hot air from flowing randomly in the accommodation chamber. Its advantages lie in cooling down circuit boards, HDD or power supply very quickly and prolonging the service life of these components. However, the above descriptions are given to illustrate an example of preferred embodiments of the present invention, and shall not be construed as limiting the appended patent claims of the present invention. It is hereby declared that all modifications and equivalent structural changes made without departing from the spirit and art of the present invention shall be included in the appended patents of the present invention.

In summary, the computer cooling system as disclosed in the present invention can achieve its functions and objects when applied and embodied practically. Therefore, the present invention is really an excellent one with practical applicability and can satisfy the terms and conditions for patentability of a utility model. While the application of patent is filed pursuant to applicable laws, your early approval will be highly appreciated so as to guarantee benefits and rights of the inventor who has worked hard at this invention. For any question, please do not hesitate to inform the inventor by mail, and the inventor will try his best to cooperate with you.

What the invention claimed is:

1. A computer cooling system for using in a computer, the computer comprising a motherboard capable of executing preset programs, operating, calculating, processing and editing functions, a power supply that provides electricity to the motherboard, a CD/DVD drive, a hard disk drive (HDD) and a burner, and the motherboard comprises a CPU, at least one chip, at least one interface card and at least one memory card, wherein:
the computer comprising an accommodation chamber which comprises a first accommodation space to accommodate the motherboard and the CD/DVD drive and burner electrically connected to the motherboard, one or more first air inlets and first air outlets provided respectively on two adjacent side walls of the first accommodation space to guide external air in and discharge hot air outwards, a second accommodation space arranged based on the position of the interface card and memory card electrically connected to the motherboard and adjacent to the first accommodation space, one or more second air inlets provided on one side wall of the second accommodation space to draw in external air, one or more second air outlets provided on the other two opposite side walls of the second accommodation space to discharge hot air outwards, and a third accommodation space for accommodating the power supply one or more third air inlets provided on one side wall of the third accommodation space to draw in external air, and one or more third air outlets provided on the adjacent side wall of the third accommodation space to discharge hot air outwards.

2. The computer cooling system according to claim 1, wherein the computer may be a desktop computer, a server host or a micro computer.

3. The computer cooling system according to claim 1, wherein the first, second and third air inlets provided on side walls of the computer are equipped with fans to draw external cold air into the accommodation chamber.

4. The computer cooling system according to claim 1, wherein the first, second and third air outlets on side walls of the computer are provided with multiple ventilation apertures or cooling fans to discharge hot air from the accommodation chamber, and the fans are mechanical or water-cooled fans.
